(19) United States
(12) Patent Application Publication
(10) Pub. No.: US 2007/0255951 A1
(43) Pub. Date: Nov. 1, 2007

(54) Token Based Multi-protocol Authentication System and Methods

(76) Inventor: Amiram Grynberg, (US)

Correspondence Address: AMIRAM GRYNBERG, 24 RIMON ST, NEVE EFRAYIM MONSON, 60190, IL

(21) Appl. No.: 11/561,396

(22) Filed: Nov. 19, 2006

Related U.S. Application Data
(60) Provisional application No. 60/597,276, filed on Nov. 21, 2005.

(51) Int. Cl. H04L 9/00

(52) U.S. Cl. 713/168

(57) ABSTRACT

A Token based, multi-Server and multi-protocol authentication system comprising a plurality of Servers employing potentially a plurality of Proof protocols each requiring a Proof of Token presence before accepting login request from a possessor of said Token and a plurality of Token apparatus capable of communicating with said Servers and storing at least a first private key accessible only to Token, whereby said first key is associated with a Manufacturer Certificate; and whereby each Token is capable of executing a plurality of Proof of possession protocols such that for each Server of the plurality of Servers there is at least one protocol common to Token and Server.

### CROSS-REFERENCE TO RELATED

Provisional Application by the same inventor, the benefit of which is hereby claimed 60/597,276

### BACKGROUND OF THE INVENTION

The internet in general and the World Wide Web in particular, help people and organizations connect with each other for business and pleasure. However, the Internet also proves to be a new play media for scamming and fraud.

As more people (Users) enter personal and private data into Web forms through web browsers, other parties (attackers) have looked for ways to defraud Users and retrieve said personal data using various methods.

As a result, in late 2005 the US Federal Financial Institutions Examination Council has recommended that all banks use 2 factor authentication methods to authenticate online Users, by the end of 2006.

It is envisioned, that consumers will be able to purchase a generic token at a retail store and enroll that token with multiple websites.

What is required are methods and apparatus which can provide a Proof that a User requesting login to a website (“Server”) is indeed in possession of a particular piece of hardware (“Proof” of something they have).

There are known in the art many methods for using hardware Tokens as the second factor for User authentication. However, these solutions are a single site solution whereby a User is issued a hardware Token by a particular institution and that Token is only valid for authenticating that User to that institution.

Such methods include one time password generators (OTP) and certificate identifying a User stored inside hardware Token.

The fact that each Token is geared for a specific site is not User friendly and costly, thus it has stopped many consumers from adopting hardware Token solutions.

Proof methods (“protocols”) are divided into two groups. In the first group are protocols which use secret data shared between a Server and a Token. In the second group no secret is shared. Instead, asymmetric cryptography is used.

Shared secret protocols are long known to those skilled in the art. A first method disclosed by U.S. Pat. No. 4,601,011, uses two counters one stored within Token and one within Server. A shared secret between Server and Token is required to encrypt and decrypt counter values. Furthermore, U.S. Pat. No. 4,601,011 discloses storing multiple shared secrets within Token and selectively using a shared secret stored within Token related to a particular Server.

Alternatively when no secrets are shared, a single Token can be used to authenticate to multiple Servers like the method disclosed by patent application 20050050330. However, anonymity is lost because all Servers are now aware of a unique ID of a particular Token represented through its public key.

More so, in a real world not all Servers use the same method or protocol for accepting Proofs from Users thereby requiring Users to carry multitude of Tokens.

It is therefore highly desirable and beneficial to use methods and devices whereby a single hardware Token device (Token) can be used to authenticate a User to multiple institutions or websites. A Token can take a form of a stand-alone device with a display for communicating an OTP or it can be connectible to a Server directly or via Host computer (“Host”) using electronic communication means like USB port, wireless connection, Internet local net etc.

It is also advantageous if those methods do not rely on trusting Severs, thus, secret information related to authenticating a User by one Server cannot be used to authenticate that same User to another Server.

Further, since there is not in existence a single standard or protocol dictating such methods, it is desirable to have a single Token and associated methods that comply with a multiplicity of authenticating protocols.

Additional advantage to Users would be anonymity. That is if a Token would not disclose to all Servers a single common identifier that would permit tracking of User activity by exchanging such identifier information among Servers.

Some Tokens allow for software emulation of Token's functionality. Such Tokens do not provide for real “what you have” Proof since data files used by software can be copied and re-used thus providing no Proof that a unique physical entity is present as a second factor. Thus, it is advantageous to have a solution whereby a unique physical possession is proved.

### SUMMARY OF THE INVENTION

The current invention describes system and related methods, based on a single Token, for efficiently providing for authentication of Users to a plurality of Servers using a multiplicity of anonymous authentication protocols.

This invention is based on a hardware Token (“Token”) defined as a secure physical entity whereby some authentication related operations can be carried out only by such entity thus, proving to a Server that a User is in possession of a particular Token. A Proof of possession constitutes data which can be represented as character or binary data. A single Token can provide Proofs to multiple Servers employing a plurality of protocols.

In accordance with a first embodiment of this invention, a Token is not electronically connected to a Server except during an enrollment phase, during which data is shared between Token and Server, thus providing for a flexible solution. With this first embodiment, selection of Server and receiving Proof data from a Token is performed manually by a User. Communication with Server is carried out by said User.

In accordance with a second embodiment of this invention, a Host computing device serves as an interface between a Server and a Token. In this second embodiment, the process is automated as Server selection and transmission of Proof data are carried out by a program executing on said Host device.

In accordance with a first set of methods of the present invention, a Proof is calculated completely within a Token or by a Token in conjunction with a Host device. However, in any variation, computing a Proof is not possible without at least one step which requires execution by a Token in a secure manner.

This invention further discloses methods for enrolling Tokens to Servers and for transfer of secret data from one Token to another. Both methods use public key cryptography.

### BRIEF DESCRIPTIONS OF THE DRAWINGS

no drawings

### DETAILS OF THE INVENTION

The current invention describes a system and methods, based on a single hardware Token, for efficiently providing for authentication of Users to a plurality of Servers using a multiplicity of anonymous authentication protocols.

For the purpose of the current invention, the following roles are defined:

“User”—a person who wishes to authenticate to a Server.

“Server”—an application or website which requires Users to provide authentication credentials, before they are allowed access, whereby at least one mandatory credential is Proof of possession of hardware Token. In some cases Server may be local and share the same hardware as the Host, however, it retains its functionality as an authenticating Server. Example, application running on a local computer and having HTML based UI, or application running on local computer having login verification logic.

“Host”—a computing device accessible to User. It could be a PC, hand held device or any other device having input means responsive to User or Input means responsive to Token or both.

“Token”—a hardware device implementing cryptographic algorithms and secure storage required for executing Proof of possession logic. A Token may take a form of a secure device within a larger computing device (i.e. Host). For example, a cellular phone may have a Token functionality and Host functionality within same hardware enclosure but Token functionality and secure store are only accessible via controlled functions of Token.

“Proof of possession” (or “Proof”)—a calculated data element that provides to a Server a Proof that said data element was calculated by a particular Token previously enrolled to Server.

“Protocol”—an algorithm associated data and transfer methods related to a each Proof of possession method.

Some non secure functions carried out by a Token when implementing a protocol, can be shared with a Host when one exists. Therefore when referring to a Token in the current invention, this reference may include a Host as well depending on the particular division of responsibility between said Host and Token. However, a unique and mandatory feature of all Tokens described by this invention is that it is not possible to carry out a Proof of possession algorithm without involving at least one operation carried out by the Token in a secure manner and involving at least one securely stored data element.

In accordance with a preferred embodiment of this invention, a Token can communicate with devices external to Token via first electronic communication means similar to USB connections and wireless connections. In addition a Token can optionally have a display, some input means responsive to User and an internal battery allowing Token to operate independently from said first communication means.

Each Token stores at least a first private key within said Token accessible only to Token's internal logic, whereby an associated digital certificate is associated with said first private key. The digital certificate does not directly identify a User or Token.

The digital certificate, issued by the manufacturer of the Token (“Manufacturer Certificate” or “MC”), claims that the public key associated with a private key stored within Token is unique to that Token among at least all Tokens manufactured by that manufacturer. Additionally, said certificate guaranties that a Token in possession of a private key associated with a certificate is a complying Token.

A complying Token is defined as a Token supporting a minimum set of specifications like the ones descried in this invention. Furthermore, a complying Token will not allow for specified data elements, secured by a Token, to be made available outside a complying Token in a clear text form.

Patent no. EP 1197053 discloses a Token storing a private key and a MC and management thereof.

Enrolling a Token

Before using a Token to prove possession to a Server, a Token needs to be enrolled to that Server. During enrollment, a static data element is shared between Server and Token. Said static element may be secret to Server and Token of it may by a public key as described herein below.

In a first preferred enrollment method for protocols using shared secret methodology, a secret has to be shared between Server and Token. During an initial sign-up process to a Server or later update, a User enters standard sign-up data like a User name, email password etc. In addition, a program running on Host queries a Token for its MC and enters said certificate data to a field of the enrollment form. Upon receipt of an enrollment form, Server generates a data item to be secretly shared with Token. Server then encrypts said shared secret by Token's public key available through its certificate, saves a copy of said secret in a database record associated with User and sends back said encrypted secret to Host device. Host device can save the encrypted shared secret or pass it on to a Token for secure storage within Token.

By encrypting said shared secret by the private key of the Token, Server guarantees to itself that any function carried out with the decrypted version of the shared secret must be performed by an entity in possession of the private key corresponding to the public key used for encryption.

By submitting a MC to Server during enrollment, Server is assured that any entity in possession of said private key must be a Token manufactured by said manufacturer and in compliance with security specifications acceptable to Server. Thus, Server can safely assume that any entity providing a Proof that it used the decrypted shared secret is indeed in possession of the same Token used for enrollment.

In a second preferred enrollment method for protocols using asymmetric key methodology, Server does not create a shared secret, instead it stores a public key (or a digest thereof) received from User enrollment form in a database record associated with said User.

To guarantee, during future login attempts, that an entity is in possession of the same Token used for enrollment, an entity must encrypt information, known to Server, by a private key associated with the public key used for enrollment and then send said encrypted message to Server. A Server receiving said message, retrieves a public key related to said entity requesting access, and decrypts said encrypted message. A Server can retrieve said public key from storage or it can receive a copy of the public key in the login form and then compare a digest of said public key with a digest stored in a database record to assure that indeed the same public key was used during enrollment and login steps.

The problem with both enrollment methods is that they involve a unique identifier of a Token (public key) and by inference a User who is in possession of said Token. To facilitate an anonymous enrollment to multiple Servers, different MCs need to be employed for different Servers.

Thus, in a preferred embodiment of the present invention, a method is introduced for creating multiple asymmetric key sets by single Token and obtaining MCs authenticating said sets. A Token responsive to a User request, generates a new pair of asymmetric keys. Said Token then digitally signs the generated public key part and submits the signed message together with an MC accessible to Token to Host which forwards it to a certificate authority (CA) authorized to issue MCs. Said CA verifies the MC of the requesting Token and then issues its own MC for the new public key part. The new MC is then sent back to Token where it can be stored within Token or external to Token, as it contains no secret information.

Providing Proof of Possession

Following a successful enrollment, a Token can be used to produce a Proof of Possession as a factor for logging in to Server.

A first step in producing a Proof comprises selecting a Proof protocol that matches at least one Proof protocol acceptable to Server. The list of protocols supported by Host and Token can be inferred by Host from data retrieved from Token. An MC can also be used whereby a field in the MC contains a version number or other information indicative of supported protocols. The list of protocols acceptable to Server can be communicated to Host or User through a form presented to User for performing login operation or any other electronic message. Alternatively, an identifier of acceptable protocol can be stored by Host in a list during enrolment.

A second step in producing a Proof comprises retrieving a first static data element secured by Token corresponding to Server. Said first data element is either the shared secret associated with Server or a public key associated with Server (when multiple MC are in use). A list of Servers and their associated static data element can be saved and managed by Host provided that where a shared secret is involved, Host can only save an encrypted form of the shared secret.

Alternatively, a list of Servers and their associated static parts and protocols can be stored inside Token and accessed by Token in response to an identifier provided to Token, indicative of Server. This arrangement makes sense where Token is to be used as a stand alone non-connected Token. For such an implementation to work, Token should have input means used by User to select a Server record from the stored list and output means for rendering a Proof to User.

Thus in one of the embodiments of the current invention, Token has input/output means responsive to User. Selection of a Server can be performed by one of well known technologies. A first method would be one of rendering of a list of Servers on a display attached to Token and providing input means like touch sensitive display for selecting a record. Alternatively, electromechanical input means can be used to scroll through a list to display a Server record. Yet another alternative would be using voice recognition means whereby User enters commands through a microphone for selecting a Server.

It should be clear that where Token is packaged with a portable Host, like in a case of a cellular phone, Host input output means could serve to effect such selections.

A third step in producing a Proof comprises selecting a first modifier element related to selected protocol. The nature of said modifier depends on the protocol but for all protocols, said modifier is not secret and should be known to Server and Token at the same time. Thus, these modifiers can be maintained by Host or by Token depending on the type of Token as described in the second step.

Proof protocols are not the subject of the current invention thus multiple known One Time Password protocols are supported as well as common challenge response ones, as describe below.

For Proof protocols using real time or time since enrollment, this modifier is a count of time (usually minutes). If maintained inside Token, it requires Token to have a battery so that it can keep track of time when disconnected. However, if stand alone mode is not required, time can be provided to Token by Host.

For Proof protocols using counters, a counter data variable is kept in non volatile memory inside Token or by Host, depending on type of Token.

For Proof protocols using challenge-response, a challenge data string is created by Server and submitted to Token to initiate the Proof process.

A fourth step in producing a Proof comprises calculating the Proof. A Proof can be calculated by Token or it can be calculated by Host. When calculated by Host, Host must use Token for at least some operations involving secured data. Specifically, where there is need to access a clear text version of a shared secret or to access the private key part of an asymmetric key pair, these steps can only be carried out by Token.

An example of a protocol using shared secret methodology, for a case whereby all possible activities are carried out by Host is provided. When calculating an OTP using SHA-1 hashing, Token must perform a hashing function on a counter using the shared secret as a key. To facilitate such operation, Token must receive from Host a shared secret encrypted by one of Token's private keys. Secondly, Token must receive indication enabling Token to determine which private key to use. Such indication may be a public key associated with Server or an identifier used to store said private key inside Token. Thirdly, Token should receive the modifier value from Host. To start calculating, Token first decrypts the shared secret using the designated private key, then Token calculates a generic SHA-1 operation using the above parameters and lastly Token returns the result to Host for further processing.

A second example of a protocol using public key methodology, for a case whereby all possible activities are carried out by Host is provided. To facilitate such operation, Token must receive from Host a modifier value such as a challenge. Secondly Token must receive indication enabling Token to determine which private key to use. Such indication may be a public key associated with Server or an identifier used to store said private key inside Token. To start calculating, Token encrypts the modifier with the selected private key and returns the result to Host for further processing.

In some cases, due to export restrictions, it is desirable to have a Token with generic crypto capabilities to carry out various Proof calculations but without providing generic encryption decryption capabilities of data. In such cases, in the example above Token could provide for encryption of an MD5 hash of a challenge and not of the challenge itself.

A fourth step in proving a possession comprises communicating said Proof to Server. In a configuration whereby Host serves as an intermediary between Server and Token, communicating to Server can be effected electronically using login forms and automatically filling out those forms. Where Server is a web site and login is performed via hi level http protocol, Host can send use html forms as communicating means.

Therefore, a preferred way of communicating Proof to Server is to integrate Host logic with a browser such that Host serves as an add-on to browser. When Host receives a response from Token, Host then automatically enters response to a field in an html form presented by browser and either submits or waits for User to submit said form to Server. Should User use a non-connected Token, User would read Proof from Token and manually enter said response into html form.

The last step of proving a possession involves calculating a verification protocol at Server. This step is accomplished by Server from saved static data element (or a digest thereof in case of a public key) and from modifier value. Server access storage to retrieve values related to a particular User from User identifier sent to Server as part of the login request. If modifier is not based on a challenge recently created by Server, then the value of modifier known to Server may be different by some limited offset from value of modifier known and used by Token to produce a Proof. OTP algorithms provide techniques to resolve such offsets and manage counters.

Transfer of Certificates

When Users upgrade their Tokens and replace them, they have to re-enroll to all Servers. This is not desirable and means are therefore provisions are needed for transfer of MCs without breaking down the compliance guaranty provided by an MC.

A certificate can only be transferred from one complying Token to another. When a new Token is to replace exiting Token (completely or partially), a MC, residing on the old Token needs to be transferred to the new Token (together with Server related data relying on said MC).

Thus, in accordance with a preferred embodiment of the current invention, a new Token sends its own MC to an old Token (using electronic means via Host). Said old Token first verifies the new MC, and then it encrypts a private key related to an old MC to be transferred, with the public key provided in the new MC. Before returning the encrypted private key and its associated old MC and Server records to the new Token and to insure compliance, old Token deletes the old MC and its private key. Upon receiving the encrypted old MC, the new Token stores it and its related old MC and Server records related to old MC, adding it to its collection of MCs and Servers.

Alternatively, the new Token can create a secure session with old Token by establishing a session key through its public keys. This will only be done after each Token verifies the authenticity of the other Token's MC.

Caution should be taken to prevent a rogue Host from trying to steal private keys and MCs from a Token while said Token is attached to Host, by transferring these MCs to its own Token. To that end, Tokens also provide for access control using a password before activation of a transfer is allowed.

What is claimed is:

1. An authentication system comprising:
a. A plurality of Servers employing a plurality of Proof protocols each requiring a Proof of Token presence before accepting login request from a possessor of said Token;
b. A Token apparatus, capable of communicating with said Servers, comprising:
i. A first private key accessible only to Token and associated with a Manufacturer Certificate required for executing an enrollment protocol of Token to Server;
ii. Processing means capable of selectively executing a plurality of Proof of possession protocols, such that for each Server of the plurality of Servers there is at least one protocol common to Token and Server;
iii. Storage means for securely storing a collection of data elements, each such element corresponding to a particular Server and wherein said data element is required for producing a Proof of possession acceptable to said Server;
iv. Selection means for selecting a data element required for executing a Proof of possession protocol corresponding to a particular Server.

2. The system of claim 1 further including a Host device communicative with Token wherein protocols are executed collaboratively by Token and by a Host, wherein operations involving non secret data are carried out by Host while at least one operation, involving secret data, is carried out by Token.

3. The system of claim 1 wherein said Token renders Proof of possession on display means attached to Token and a User communicates said Proof to Server.

4. The system of claim 1 further comprising a multiplicity of Manufacturer Certificates, each selectively required for executing an enrollment protocol of Token to particular Server.

5. The system of claim 1 wherein selection means use user accessible input selector.

6. The system of claim 1 wherein selection means are speech detection and recognition means responsive to user commands.

7. A method for generating a plurality of digital certificates guarantying compliance of a Token comprising the steps of:
a. Storing within Token a first private key and a first public key during manufacturing process;
a. Generating by Token an asymmetric second private key and a matching second public key;
b. Computing by Token a digital signature to said second public key whereby said signature is encrypted by said first private key;
c. Submitting a certificate request containing at least said signature, first public key and second public key to CA;
d. Verifying at CA that first public key is registered with manufacturer;
e. Receiving at Token from CA a Manufacturer Certificate certifying said second public key.

8. The method of claim 7 wherein first public key is replaced by first MC and the step of verifying at CA is replaced by:
a. Verifying at CA that first MC is valid.

9. A method for transferring a first MC from first Token to second Token comprising the steps of:
a. Establishing a trust for second Token by First Token based on MC of second Token;
b. Deleting first private key from permanent storage at first Token;
c. Communicating encrypted first private key and associated first MC to second Token;
d. Storing first private key and associated first MC at second Token.

10. The method of claim 9 wherein establishing a trust also involves asserting that second Token knows a shared secret required to access first Token.
